(19) United States
(12) Patent Application Publication
(10) Pub. No.: US 2015/0132837 A1
(43) Pub. Date: May 14, 2015

(54) MICROFLUIDIC DEVICES FOR RELIABLE ON-CHIP INCUBATION OF DROPLETS IN DELAY LINES

(71) Applicant: UNIVERSITE DE STRASBOURG, Strasbourg (FR)

(72) Inventors: LUCAS FRENZ, STRASBOURG (FR); KERSTIN GODELINDE BLANK, KRANENBURG (DE); ANDREW DAVID GRIFFITHS, STRASBOURG (FR); ERIC BROUZES, NEW YORK, NY (US)

(21) Appl. No.: 14/606,202

(22) Filed: Jan. 27, 2015

Related U.S. Application Data
(63) Continuation of application No. 13/123,096, filed on Nov. 9, 2011, now abandoned.
(60) Provisional application No. 61/103,648, filed on Oct. 8, 2008.

(51) Int. Cl. B01L 3/00

(52) U.S. Cl. CPC B01L 3/502784; B01L 2300/0883; B01L 2400/086; B01L 2300/0816; B01L 2300/087; B01L 2200/0652; B01L 2200/0673
USPC 435/289.1; 422/502

(57) ABSTRACT

The present invention relates generally to droplet creation, fusion and sorting, and incubation for droplet-based microfluidic assays. More particularly, the present invention relates to delay-lines, which allow incubation of reactions for precise time periods. More particularly, the present invention relates to delay lines for incubations up to three hours, while reducing back-pressure and dispersion in the incubation time due to the unequal speeds with which droplets pass through the delay line.

### CROSS-REFERENCE TO RELATED APPLICATIONS

This application is a continuation of U.S. Ser. No. 13/123,096, filed Nov. 9, 2011, which is the U.S. national stage application of International Patent Application No. PCT/US2009/060041, filed Oct. 8, 2009, which claims the benefit of U.S. Provisional Patent Application No. 61/103,648, filed Oct. 8, 2008.

### FIELD OF INVENTION

The present invention relates generally to droplet creation, fusion and sorting, and incubation for droplet-based microfluidic assays. More particularly, the present invention relates to delay-lines, which allow incubation of reactions for precise time periods. More particularly, the present invention relates to delay lines for incubations up three hours, while reducing back-pressure and dispersion in incubation times.

### BACKGROUND OF THE INVENTION

Compartmentalization of reactions in microdroplets in emulsions has a broad range of applications in chemistry and biochemistry. Each microdroplet functions as an independent microreactor with a volume of between one nanoliter and one femtoliter, which is between 10³ and 10⁹ times smaller than the smallest working volumes in a microtitre plate well (1-2 microliters). Initially developed for directed evolution, the technique of In Vitro Compartmentalization (IVC)¹ of reactions in emulsions has allowed the selection of a wide range of proteins and RNAs for binding, catalytic and regulatory activities.^{2,3,4} However, other applications rapidly followed, notably massively parallel PCR of single DNA molecules (emulsion PCR), which is used, for example, for the Genome Sequencer FLX (Roche) and SOLiD (ABI) “next-generation” high-throughput sequencing systems.⁵ Droplet-based microfluidic systems are now further extending the range of potential applications, as they allow for the precise generation and manipulation of droplets. Microfluidic modules have been described which allow highly monodisperse droplets to be created;⁶ split;^{7,8} fused;^{7,9} sorted¹⁰ and the contents of the droplets mixed on microsecond timescales:⁷ all at high throughput (typically ≧kHz). Based on these developments, a range of applications has already been transferred to microfluidic systems such as protein crystallization,¹¹ the measurement of chemical kinetics,⁷ enzymatic assays,¹² cell based assays,^{13,14} the synthesis of monodisperse polymer beads/particles,^{15,16} the synthesis of organic molecules,^{17, 18} and the synthesis of nanoparticles.^{19, 20} Multiple modules can potentially be integrated into single microfluidic chips fabricated in poly(dimethylsiloxane) (PDMS) using soft-lithography,²¹ allowing sophisticated multi-step procedures to be executed on-chip.

For long reaction times (generally greater than 1-2 hours), microdroplets formed in microfluidic devices can be incubated within an on- or off-chip reservoir and reinjected into the microfluidic device for analysis^{13,14}. But this configuration is not practical for shorter incubation times. For very short reaction times (e.g., reaction times less than 1 min), short and narrow microfluidic channels have been used in which the droplets remain in single-file¹². However, to date, it has not been possible to create a reliable delay-line for incubation times in the extremely useful range of 1 min to 1 hour.

### SUMMARY OF INVENTION

The present invention is directed to microfluidic devices comprising delay lines which allow for reliable incubation times up to 3 hours. The delay lines of the present invention provide microfluidic devices with very low back-pressure, very low dispersion of incubation times and enough flexibility so that a range of different incubation times are accessible for a given design. The devices of the present invention may used for combinatorial library screening applications and as a powerful tool for analyzing the reactions kinetics of a wide range of chemical and biochemical reactants.

The delay lines of the present invention allow incubation of droplets flowing in a continuous phase, such as a carrier oil, for defined times in which the dispersion ratio (R) is lower than 20%. In one exemplary embodiment, the delay lines of the present invention allow incubation of droplets flowing in a continuous phase with a dispersion rate lower than 15%. In yet another embodiment, the delay lines of the present invention allow incubation of droplets flowing in a continuous phase with a dispersion rate lower than 10%.

The delay lines of the present invention provide reliable incubation times up to 3 hours. In one exemplary embodiment, the present invention provides reliable incubation times in the range of 1 minute up to 2 hours. In yet another exemplary embodiment, the present invention provides reliable incubation times in the range of 1 minute up to 3 hours.

In one embodiment, the delay lines of the present invention may comprises multiple parallel microchannels. Multi-channel delay lines may comprise from 2 to 100 channels. In one exemplary embodiment, the delay line comprises, 2, 3, 4, 5, 6, 7, 8, 9, 10, 11, 12, 13, 14, 15, 16, 17, 18, 19, or 20 channels. In another exemplary embodiment, the delay line comprises 8 channels. The diameter of each channel should be no more than three times the diameter of the droplets that will pass through the delay line. In one exemplary embodiment, the diameter of each channel is no more than two times the diameter of the droplets that will pass through the delay line.

In another embodiment, the delay lines of the present invention may comprise one or more mixing modules throughout the delay line. The mixing modules prevent droplets from remaining in the same stream lines as they transit through the delay line. Exemplary mixing modules include, but are not limited to, chaotic mixers³⁰, serpentine mixing modules³¹, or by introduction of constrictions in the delay line.

The constriction reduces the cross-section of the delay line. In one exemplary embodiment, the constriction reduces the cross-section of the delay line to equal to or less than 5 droplet diameters. In another exemplary embodiment, the constriction reduces the cross-section of the delay line to equal to or less than 4 droplet diameters. In yet another exemplary embodiment, the constriction reduces the cross-section of the delay line to equal to or less than 3 droplet diameters. In another exemplary embodiment, the constriction reduces the cross-section of the delay line to equal to or less than 2 droplet diameters. In another exemplary embodiment, the constriction reduces the cross-section of the delay line to equal to or less than 1 droplet diameter. In one exemplary embodiment the constrictions may be formed or inserted approximately every 0.5 μm to 10 cm. In another exemplary embodiment, the constrictions are formed or inserted every 3 cm.

In yet another embodiment, the microfluidic device may comprise a blocking phase module. The blocking phase module is connected to the device just upstream of the delay line and may consist of a reservoir and fluid flow actuator such as a pump. The blocking phase modulator functions to introduce a blocking phase, or plug. The plug may comprise another phase, such as another aqueous phase, oil phase, or gas, that is immiscible with the droplet and the carrier phase. As droplets enter the delay line, the blocking phase is intermittently introduced into the delay line. The amount of the blocking phase introduced into the delay line is sufficient to produce a plug spanning the entire channel of the delay line. The droplets in between two plugs cannot overtake one another resulting in reduced dispersion in droplets.

### BRIEF DESCRIPTION OF THE DRAWINGS

FIG. 1 is a diagram showing an exemplary layout of a two-depth device with a delay-line.

FIG. 2a is a graph showing the dispersion of different droplet densities in a delay line of the present invention.

FIG. 2b comprises a series of video still shots showing different droplet density regimes in an exemplary delay line and indicating differences in traveling speed due to density dependent droplet packing within the delay line.

FIG. 2c is a graph showing dispersion measurements at different droplet densities in delay line of the present invention without any active measures to reduce dispersion.

FIG. 3a is picture of an exemplary mixing module according to the present invention.

FIG. 3b is a graph showing a reduction in the dispersion measurement, as compared to FIG. 2c, resulting from the use of a delay line comprising mixing modules.

FIG. 3c is a graph showing the logistic nature of the transition measurement and indicates a Gaussian distribution of the incubation times due to the mixing modules.

FIGS. 4a-4c are diagrams showing exemplary constrictions, or barriers, that may be used in mixing modules of the present invention.

FIG. 5a is a diagram showing an exemplary multi-channel delay line of the present invention.

FIG. 5b is a graph showing the dispersion of droplets at different droplet densities in an exemplary multi-channel delay line of the present invention.

FIG. 6a is a diagram showing an exemplary microfluidic device of the present invention configured with multiple measurement points over the course of the delay line for analyzing the kinetics of a given biochemical or chemical reaction.

FIG. 6b is graph monitoring the kinetics of a beta-lactamase reaction carried out using the device of FIG. 6a.

FIG. 7 is a schematic representation of an optical system that can be used to monitor chemical and biochemical reactions carried out on an exemplary microfluidic device of the present invention.

FIG. 8 is a diagram showing an exemplary microfluidic device of the present invention configured for high throughput screening applications and the ability to functionally integrate multiple droplet manipulation modules into a single chip.

FIG. 9 is a diagram showing an exemplary microfluidic device of the present invention configured for monitoring and analyzing the kinetics of a given biochemical or chemical reaction.

### DETAILED DESCRIPTION

### Definitions

As used herein, the term “microfluidic device” or “chip”, or “lab-on-chip” or LOC refers to a device, apparatus or system including at least one fluid channel having a cross-sectional dimension of less than 1 mm, and a ratio of length to largest cross-sectional dimension of at least 3:1. A “microfluidic channel,” as used herein, is a channel meeting these criteria.

A “channel,” as used herein, means a feature on or in an article (substrate) that at least partially directs the flow of a fluid. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more typically at least 3:1, 5:1, or 10:1 or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (i.e., a concave or convex meniscus). The channel may be of any size, for example, having a largest dimension perpendicular to fluid flow of less than about 10 mm or 2 mm, or less than about 1 mm, or less than about 500 microns, less than about 200 microns, less than about 100 microns, less than about 60 microns, less than about 50 microns, less than about 40 microns, less than about 30 microns, less than about 25 microns, less than about 10 microns, less than about 3 microns, less than about 1 micron, less than about 300 nm, less than about 100 nm, less than about 30 nm, or less than about 10 nm. In some cases the dimensions of the channel may be chosen such that fluid is able to freely flow through the article or substrate. The dimensions of the channel may also be chosen, for example, to allow a certain volumetric or linear flow rate of fluid in the channel. Of course, the number of channels and the shape of the channels can be varied by any method known to those of ordinary skill in the art. In some cases, more than one channel or capillary may be used. For example, two or more channels may be used, where they are positioned inside each other, positioned adjacent to each other, positioned to intersect with each other, etc.

The “cross-sectional dimension” of the channel is measured perpendicular to the direction of fluid flow. Most fluid channels in components of the invention have maximum cross-sectional dimensions less than 10 mm, and in some cases, less than 1 mm. In one set of embodiments, all fluid channels containing embodiments of the invention are microfluidic or have a largest cross sectional dimension of no more than 10 mm or 1 mm. In another embodiment, the fluid channels may be formed in part by a single component (e.g. an etched substrate or molded unit). Of course, larger channels, tubes, chambers, reservoirs, etc. can be used to store fluids in bulk and to deliver fluids to components of the invention. In one set of embodiments, the maximum cross-sectional dimension of the channel(s) containing embodiments of the invention are less than 2 mm, less than 1 mm, less than 500 microns, less than 200 microns, less than 100 microns, less than 50 microns, or less than 25 microns.

A “droplet,” as used herein is an isolated portion of a first phase that is completely surrounded by a second phase. It is to be noted that a droplet is not necessarily spherical, but may assume other shapes as well, for example, depending on the external environment. In one embodiment, the droplet has a minimum cross-sectional dimension that is substantially equal to the largest cross-sectional dimension of the channel perpendicular to fluid flow in which the droplet is created.

The “average diameter” of a population of droplets is the arithmetic average of the diameters of the droplets. Those of ordinary skill in the art will be able to determine the average diameter of a population of droplets, for example, using laser light scattering or other known techniques known to one of ordinary skill in the art. The diameter of a droplet, in a non-spherical droplet, is the mathematically-defined average diameter of the droplet, integrated across the entire surface. As non-limiting examples, the average diameter of a droplet population may be less than about 1 mm, less than about 500 micrometers, less than about 200 micrometers, less than about 100 micrometers, less than about 75 micrometers, less than about 50 micrometers, less than about 25 micrometers, less than about 10 micrometers, or less than about 5 micrometers. The average diameter of the droplet may also be at least about 1 micrometer, at least about 2 micrometers, at least about 3 micrometers, at least about 5 micrometers, at least about 10 micrometers, at least about 15 micrometers, or at least about 20 micrometers in certain cases. As used herein, the term “on-chip” refers to structures, modules, and other components located on or within a microfluidic device or microfluidic system, as well as the handling and processing of reagents on or within a microfluidic device or system.

As used herein, the term “off-chip” refers to structures, modules, and other components that may be integrated with or connected to, but do not form part of, the microfluidic device, as well as the handling or processing of reagents off or outside of a microfluidic device.

As used herein, the term “upstream” refers to components are modules in the direction opposite the flow of fluids from a given reference point in a microfluidic device.

As used herein, the term “downstream” refers to components or modules in the direction of the flow of fluids from a given reference point in a microfluidic device.

As used herein, the term “delay line” refers to one or more microchannels in a device wherein two or more reagents are incubated in order to allow a chemical, biochemical, or enzymatic reaction to proceed.

As used herein, the term “incubation time” refers to the time it takes a droplet to traverse the delay line; the term “transition time” refers to the time between the arrival of a first droplet with low activity (i.e. fluorescence) and the arrival of a last drop with high activity (i.e. fluorescence); the term “dispersion” refers to the variation in the incubation times for droplets of a given size, droplet density, or oil/aqueous ratio; and “dispersion ratio (R)” refers to the ratio of dispersion to the average transition time.

The microfluidic devices of the present invention can be used to create and manipulate droplets with diameters typically ranging from 0.1 μm to 1 mm. In order to create and manipulate such droplets, the channels connecting the various components in the microfluidic device need to have dimensions similar to the droplet size. However, construction of delay lines needed to provide incubation times in a desired range of up to 3 hours is not possible as long channels with small cross-sectional dimensions generate unacceptable levels of back pressure, hindering their usage over the entire scope of the device. The present invention provides novel microfluidic delay line configurations utilizing wider and/or deeper channels which allow for incubations within the desired time range without the concomitant back pressure issues of other configurations. The delay line configurations with wider and/or deeper channels may then be combined with upstream and downstream modules with shallower channels suited for pre- and post-incubation manipulation of droplets.

In addition to addressing the pressure problem, the present invention also addresses the issue of dispersion of incubation times. A well known phenomenon in microfluidic single phase flows is the so-called Taylor dispersion of reagents due to the parabolic flow profile within the channels (Poiseuille flow) (25). As a consequence, the flow rate in the center of the channel is higher than the flow rate close to the walls. Therefore, as soon as a channel is wide enough for droplets to overtake each other, the different flow rates give rise to differences in droplet speed. The central droplet stream can flow faster that the stream closer to the walls, thereby leading to significant differences in the incubation times of individual droplets. The present invention provides novel delay line configurations that reduce the overall dispersion of incubation times.

One of the main applications for droplet-based microfluidics is high-throughput screening, the ability to screen and, optionally, sort droplets at speeds up to the kHz range. The delay-line configurations of the present invention provide an essential tool for carrying out these applications. In almost all cases the reaction involved (e.g. an enzyme/substrate or an enzyme/substrate/inhibitor system) start at a fixed point in time and, therefore, every reaction (i.e. every droplet) needs to be incubated for exactly the same time. Microfluidic devices allow for precise initiation of reactions via co-flowing different reactant streams or fusion of separate droplets containing the necessary reactants. After incubating each droplet the screening determines the activity within each droplet. In the case of effectors, this would be a screen for droplets presenting a reaction with higher activity, or in the case of inhibitors, a screen for droplets of reactions with lower activity. In addition, microfluidic devices can be used to analyze concentration dependencies. Droplets containing different concentrations of reagents can be created using microfluidics and analyzed to determine how concentration affects activity. For all of the above applications, it is necessary for each droplet to have a relatively equal incubation time to be quantitative. The novel microfluidic device configurations provide the means to carry out such quantitative analysis and high throughput screening by drastically reducing the dispersion of incubation times as the droplets traverse the delay line.

The delay lines of the present invention allow incubation of droplets flowing in a continuous phase, such as a carrier oil, for defined times in which the dispersion ratio (R) is lower than 20%. In one exemplary embodiment, the delay lines of the present invention allow incubation of droplets flowing in a continuous phase with a dispersion rate lower than 15%. In yet another embodiment, the delay lines of the present invention allow incubation of droplets flowing in a continuous phase with a dispersion rate lower than 10%.

The delay lines of the present invention provide reliable incubation times up to 3 hours. In one exemplary embodiment, the present invention provides reliable incubation times in the range of 1 minute up to 2 hours. In yet another exemplary embodiment, the present invention provides reliable incubation times in the range of 1 minute up to 3 hours. In another exemplary embodiment, the present invention provides reliable incubation times in the range of 1 minute up to 1 hour.

The delay lines may have a length from about 1 μm to 100 m. In one exemplary embodiment, the delay line has a length of 100 μm to 10 m. In another exemplary embodiment, the delay line has a length of 1 cm to 1 m. In yet another exemplary embodiment, the delay lines has a length of 10 cm to 1 m.

The delay lines may have a width from about 1 nm to 1 m. In one exemplary embodiment, the delay line has a width of 1 μm to 1 cm. In another exemplary embodiment, the delay line has a width of 10 μm to 10 mm. In yet another exemplary embodiment, the delay line has a width of 50 μm to 2 mm. The width of the delay line may be consistent over the entire length of the delay line or may vary in one or more sections within the ranges specified above. In one exemplary embodiment, the width of the delay line exceeds the diameter of the droplets passing through the delay line over the entire length of the delay line. In another exemplary embodiment, the width of the delay line exceeds the width of the droplets passing through the delay line over a portion of the delay line.

The delay lines may have a height from about 1 nm to 1 m. In one exemplary embodiment, the delay line has a height from 1 μm to 1 cm. In another exemplary embodiment, the delay line has a width of 10 μm to 10 mm. In yet another exemplary embodiment, the delay lines has a width of 50 μm to 2 mm. The height of the delay line may be consistent over the entire length of the delay line, or may vary in one or more sections within the ranges specified above. In one exemplary embodiment, the height of the delay lines exceeds the diameter of the droplets passing through the delay line over the entire length of the delay line. In another exemplary embodiment, the height of the delay line exceeds the width of the droplets passing through the delay line over a portion of the delay line.

The delay lines may have a width to height ratio of 1:1 to 1000:1. In one exemplary embodiment, a delay line of the present invention may have a width to height ratio of 1:1 to 100:1. In another exemplary embodiment, a delay line of the present invention may have a width to height ratio of 1:1 to 50:1. In yet another exemplary embodiment, a delay line of the present invention may have a width to height ratio of 1:1 to 25:1.

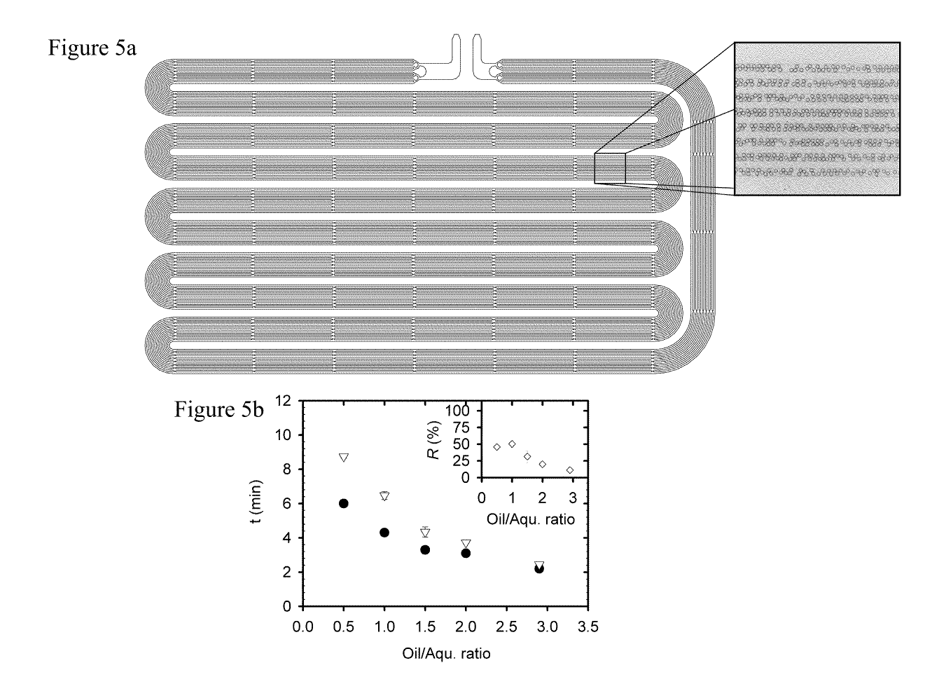

In one embodiment, the delay lines of the present invention may comprises multiple parallel microchannels. A representative multi-channel delay line is shown in FIG. 5. Multi-channel delay lines may comprise from 2 to 100 channels. In one exemplary embodiment, the delay line comprises 8 channels. The diameter of each channel should be no more than four times the diameter of the droplets that will pass through the delay line. In one exemplary embodiment, the diameter of each channel is no more than three times the diameter of the droplets that will pass through the delay line. In another exemplary embodiment, the diameter of each channel is no more than two times the diameter of the droplets that will pass through the delay line. The limited width of each channel prevents the formation of a fast central stream of droplets within each channel. In one exemplary embodiment, the width of each channel in the delay line is no more than 4 times the diameter of the droplets. In another exemplary embodiment, the width of each channel in the delay line is no more than 3 times the diameter of the droplets. In yet another exemplary embodiment, the width of each channel in the delay line is no more than 2 times the diameter of the droplets. The ranges for the length or height of each channel are similar to those described above for single channel delay lines. In order to reduce the impact of any irregularity in the delay line (i.e. dirt, channel depth fluctuations, etc.) bridges maybe added between the channels, to allow cross-flow between the channels. The bridges may be formed or inserted every 1 μm to 50 cm throughout the delay line. In one exemplary embodiment the bridges are formed or inserted every 3 cm.

In another embodiment, the delay lines of the present invention may comprise one or more mixing modules throughout the delay line. The mixing modules prevent droplets from remaining in the same stream lines as they transit through the delay line. Exemplary mixing modules include, but are not limited to; chaotic mixers³⁰, such as three dimensional L-shaped channels and three dimensional connected out-of-plane channels; serpentine mixing modules³¹, such as staggered-herringbone grooves; or by introduction of constrictions in the delay line.

The constriction reduces the cross-section of the delay line. In one exemplary embodiment, the constriction reduces the cross-section of the delay line to equal to or less than 5 droplet diameters. In another exemplary embodiment, the constriction reduces the cross-section of the delay line to equal to or less than 4 droplet diameters. In yet another exemplary embodiment, the constriction reduces the cross-section of the delay line to equal to or less than 3 droplet diameters. In another exemplary embodiment, the constriction reduces the cross-section of the delay line to equal to or less than 2 droplet diameters. In another exemplary embodiment, the constriction reduces the cross-section of the delay line to equal to or less than 1 droplet diameter. In one exemplary embodiment the constrictions may be formed or inserted approximately every 1 μm to 50 cm. In another exemplary embodiment, the constrictions are formed or inserted every 3 cm.

In one exemplary embodiment, the constriction is the result of a reduction in the width, height, or both, of the delay line. In another exemplary embodiment, the constriction is the result of the insertion or formation of an obstacle in the center of the delay line. In yet another exemplary embodiment, the constriction is the result of the insertion or formation of an obstacle extending from one or both sides of the delay line into the center of the delay line and perpendicular to the flow of droplets through the delay line. In another exemplary embodiment, the constriction further comprises the insertion or formation of an obstacle from the top, the bottom, or both the top and bottom, of the delay line into the center of the delay line and perpendicular to the flow of droplets in the delay line.

The barriers may be formed from the same material as the delay line, or a different material. The barrier may be rectangular, triangular, circular, oval, or oblong in shape. In one exemplary embodiment, the barrier is triangular in shape with a sharp tip that extends into the center of the delay line.

In yet another embodiment, the microfluidic device may comprise a blocking phase module. The blocking phase module is connected to the device just upstream of the delay line and may consist of a reservoir and fluid flow actuator such as a pump. The blocking phase modulator functions to introduce a blocking phase, or plug. The plug may comprise another phase, such as another aqueous phase, oil phase, or air, that is immiscible in the carrier phase. As droplets enter the delay line, the blocking phase is intermittently introduced into the delay line. The amount of the blocking phase introduced into the delay line is sufficient to produce a plug spanning the entire channel of the delay line. The droplets in between two plugs cannot overtake one another resulting in reduced dispersion in droplets.

### Microfluidic Devices

The delay lines of the present invention may be integrated into any microfluidic device in which incubation of one or more reagents is required.

Microfluidic devices of the present invention may be silicon-based chips and may be fabricated using a variety of techniques, including, but not limited to, hot embossing, molding of elastomers, injection molding, LIGA, soft lithography, silicon fabrication and related thin film processing techniques. In one embodiment, soft lithography in PDMS may used to prepare the microfluidic devices of the present invention.

Suitable materials for fabricating a microfluidic device include, but are not limited to, cyclic olefin copolymer (COC), polycarbonate, poly(dimethylsiloxane) (PDMS), poly(methyl methacrylate) (PMMA), and glass. In one exemplary embodiment, the microfluidic devices of the present invention are fabricated from PDMS.

Due to the hydrophobic nature of some polymers, such as PDMS, which adsorbs some proteins and may inhibit certain biological processes, a passivating agent may be necessary (Schoffner et al. Nucleic Acids Research, 1996, 24: 375-379). Suitable passivating agents are known in the art and include, but are not limited to silanes, parylene and DDM.

A microfluidic device of the present invention may comprise microfluidic valves for controlling fluid access between one compartment, reservoir, channel, or other component of the device. Suitable microfluidic valves include, for example, hydraulic, mechanic, pneumatic, magnetic, and electrostatic actuator flow controllers with at least one dimension less than 500 μm. Examples of suitable valves include flap valves, hydrogel valves, pinch valves, wax valves, membrane valves, check valves and elastomeric valves.

A microfluidic device of the present invention may comprise inlets and outlets, or openings, which in turn may be connected to valves, tubes, channels, chambers, syringes and/or pumps for the introduction and extraction of fluids into and from the microfluidic device.

A microfluidic device of the present invention may comprise fluid flow actuators that allow directional movement of fluids within a microfluidic device. Exemplary actuators include, but are not limited to, syringe pumps, mechanically actuated recirculating pumps, electroosmotic pumps, bulbs, bellows, diaphragms, or bubbles intended to force movement of fluids, where the substructures of the actuator having a thickness or other dimension of less than 1 millimeter.

A microfluidic device of the present invention may also comprise droplet synchronization modules connected upstream or downstream of the delay line. A microfluidic device may also further comprise modules that allow fusion of droplets, mixing of droplet contents, splitting of droplets, densifying of droplets (i.e. by removing carrier oil), spacing droplets (i.e. by adding carrier oil), and sorting of droplets. In each case the modules may be placed either upstream or downstream of the delay line depending on the application and desired functionality. For example, an exemplary microfluidic device may comprise in the following order: a synchronization module for the generation of a first set and set of droplets comprising different components; a fusion module comprising a fusion nozzle to allow fusion of the first and second droplets; a mixing module to insure homogenous mixing of the contents of the fused droplets; a splitting module to reduce the size of the droplets prior to entry into the delay line; a densifying or oil extraction module for removing carrier oil, a delay line for incubating the fused droplets; a spacing module; and a sorting module.

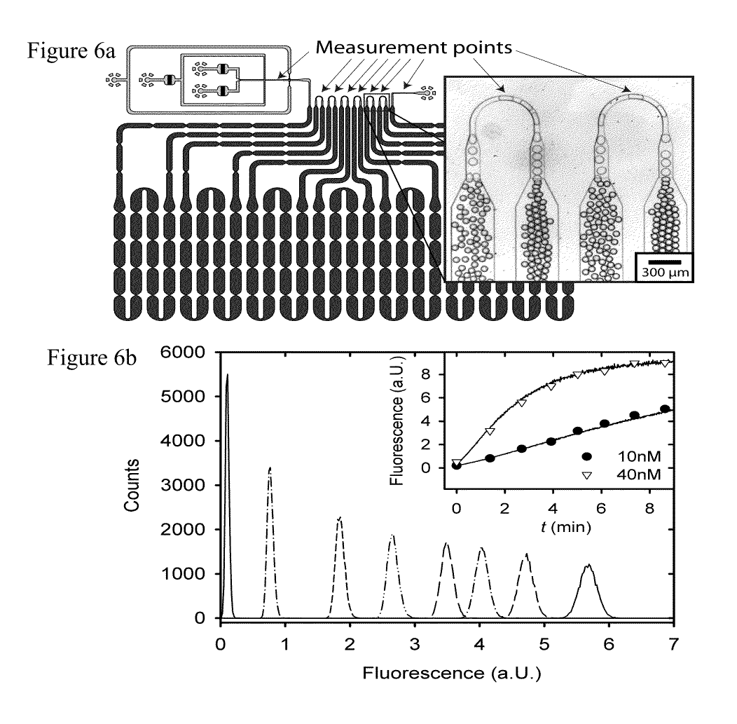

An exemplary synchronization comprises two nozzles for generation, or reinjection, of a first phase at one nozzle and generation, or reinjection, of a second phase at the second nozzle. Droplet generation/reinjection can be synchronized by modulating the flow rate through each nozzle to generate or inject droplets comprising the first and second phase in alternating fashion. An exemplary fusion module comprises a chamber and channel where the droplets coalesce either passively, or actively through, for example, introduction of hydrophilic patches on the chamber/channel walls or electrical fields. An exemplary densifying and spacing module is shown in FIG. 6. An exemplary sorting module may use dielectrophoresis²⁸ or fluorescence-activated sorting using dielectrophoresis²⁹.

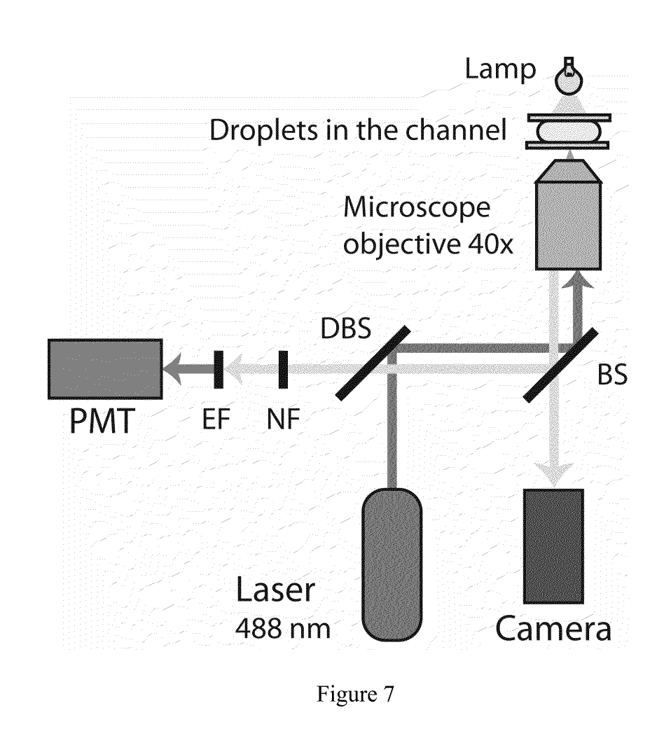

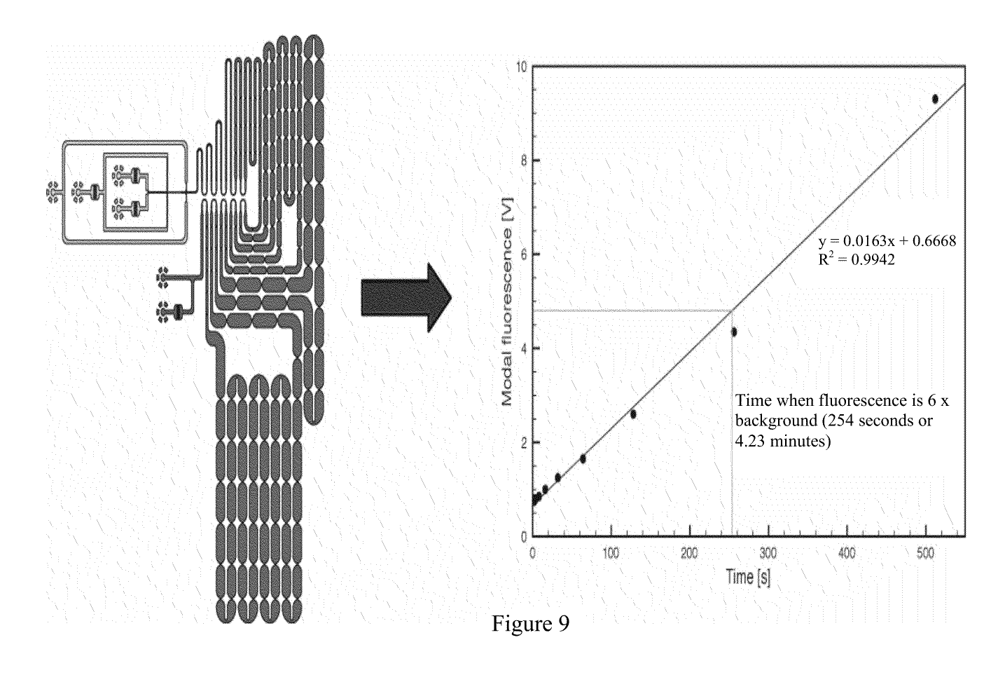

A microfluidic device of the present invention may also further comprise detection modules (i.e. for detection of fluorescence) may be placed upstream, downstream, or within the delay lines. An exemplary microfluidic device comprising detection modules is shown in FIGS. 6 and 9. An exemplary optical system for use with detection modules is shown in FIG. 7.

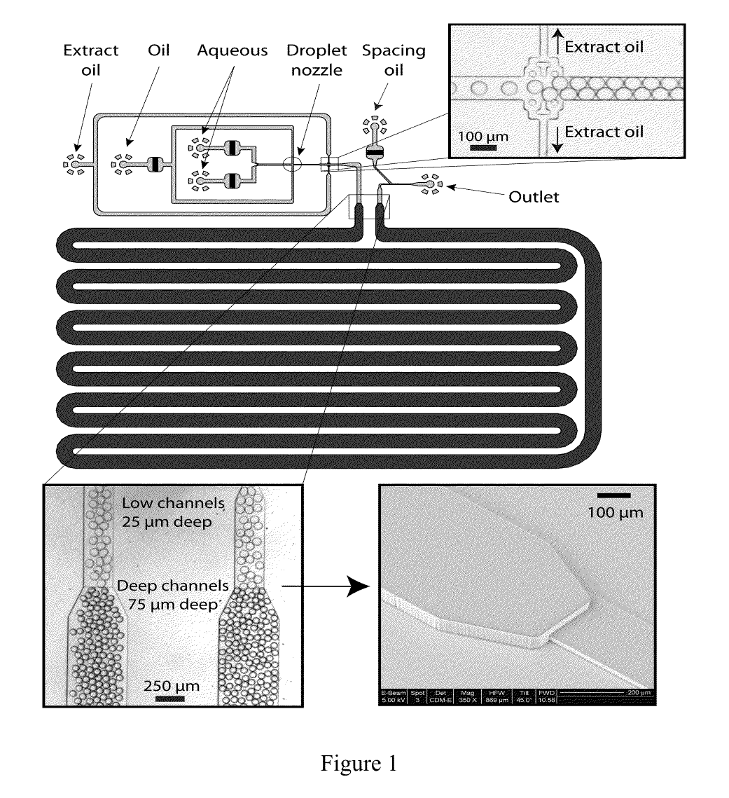

In one exemplary embodiment, the microfluidic device comprises one or more aqueous phase reservoirs and one or more oil phase modules connected via a droplet nozzle, as well as an oil extraction module connected downstream of the droplet nozzle, a delay line connected downstream of the oil extraction module, a spacing module and an outlet connected downstream of the delay line. An exemplary microfluidic device is shown in FIG. 1.

### Applications

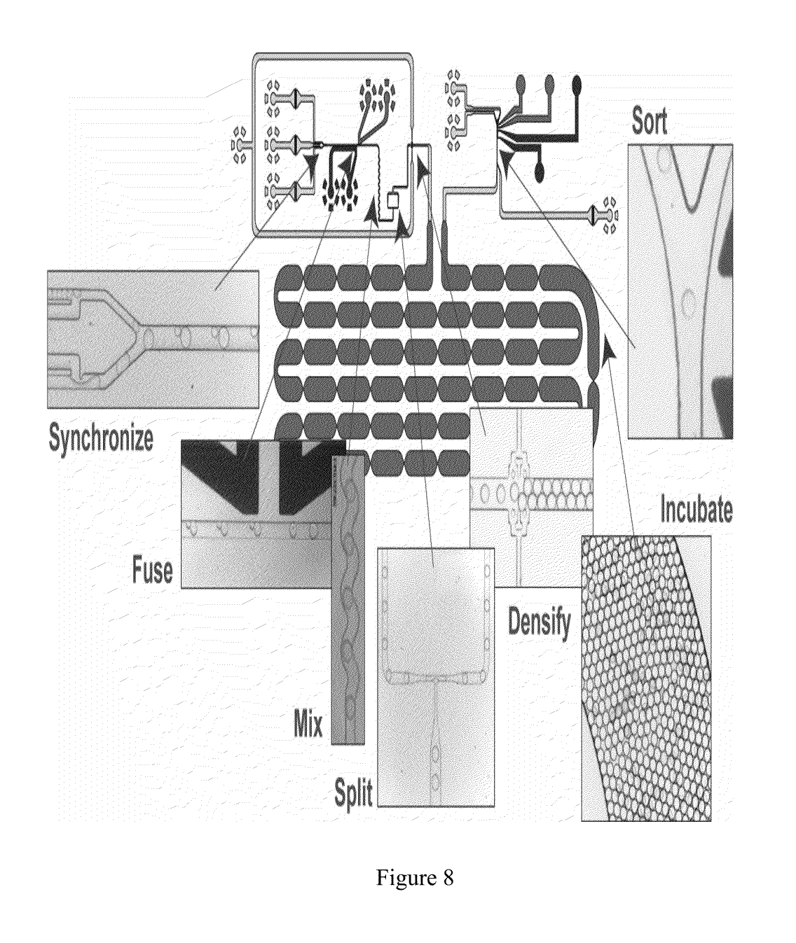

The microfluidic devices of the present invention can be configured for screening applications. Any kind of library emulsion, comprising droplets, which contain a repertoire of compounds, and where each droplet contains only, or at most, a few different compounds, may be injected through an inlet or inlets in the device and then fused to droplets containing, for example, an enzymatic target and a detectable substrate, such as a fluorgenic substrate. The fused droplets can then be incubated in the delay lines, analyzed, and optionally sorted based on the enzymatic activity. Screening may also be accomplished by co-flowing a first stream comprising a first set of components and a second stream comprising a second set of components, compartmentalized, incubated and screened. Alternatively, the library emulsion can be synchronized on chip to form droplets containing a compound of interest, and the droplets can then be fused to droplets containing the detectable substrate to initiate the reaction. Since the droplets are well spaced and well controlled after fusion of the droplet pairs, it may be favorable to split them down to smaller droplets to allow for easier sorting after incubation. The ability to split the fused drops is dependent on the contents of the fused droplet being homogenous, therefore a mixing module may be necessary before the splitting module. Incubation times can be further modulated by the extraction of oil from the droplets just prior to entering the delay line. The incubation time is inversely proportional to the reduction of the total flow rate through a delay line. For example, if the total flow rate (oil plus aqueous) is reduced by reducing the oil flow rate by a factor of 2, the incubation time increases by a factor of 2. After exiting the delay line a spacing module will be needed to re-space the droplets prior to being sorted. An exemplary microfluidic device configured for use in combinatorial screening applications is shown in FIG. 8.

The microfluidic devices of the present invention may also be configured to conduct kinetic measurements of chemical and biochemical reactions. FIGS. 6 and 9 provide an exemplary embodiment of a microfluidic device configured for kinetic measurements. Multiple measurement points may be introduce both right after formation of the droplets and initiation of the reaction as well as throughout the delay line so that the reaction may be followed over time. The measurement points can be spaced so as to provide measurements at designated time intervals. For example, the measurement points in FIG. 9 are spaced so that measurements are taken at exponentially increasing time-intervals. This leads to an oversampling of the fast kinetic region, but still covers the entire reaction profile of several minutes to several hours. See Example 6 below regarding the kinetic measurement of a β-lactamase reaction using a device of the present invention.

All patents and patent publications referred to herein are hereby incorporated by reference in their entirety. All publications mentioned in the above specification, and references cited in said publications, are herein incorporated by reference in their entirety. Various modifications and variations of the described methods and system of the invention will be apparent to those skilled in the art without departing from the scope and spirit of the invention. Although the invention has been described in connection with specific preferred embodiments, it should be understood that the invention as claimed should not be limited to such specific embodiments. Indeed, various modifications of the described modes for carrying out the invention which are obvious to those skilled in microsystems engineering or related fields are intended to be within the scope of the following claims.

### Examples

### 1. Fabrication of Microfluidic Devices with Delay Lines

Soft-lithography in poly(dimethylsiloxane) (PDMS, Sylgard 184, Dow Corning) was used to prepare the devices.²¹ The molds consisted of SU-8 (Microchem) with two different heights.²⁶ The following procedure was used: A first thinner SU-8 layer (25 μm) was spin coated and exposed to a mask which covers the part of the wafer designated to the deeper structures. After fully developing and baking the structures, a second higher layer of SU-8 was spin coated onto the same wafer. This second layer was exposed and structured by a second mask (delay-line), which was aligned to the lower structures in a mask aligner. Designing the connectors (FIG. 1) in close proximity to each other facilitated the alignment and made it less prone to angle misalignments.

After casting the mold in PDMS and binding it to a glass side (after activation in an oxygen plasma) the channels were made hydrophobic using a commercial surface coating agent (Aquapel, PPG Industries). The flow rates were controlled by syringe pumps (PHD2000; Harvard Apparatus). In all experiments, flow rates of 400 μL h⁻¹ for the oil phase and 100 μL h⁻¹ in total for the aqueous phases were used to create 53 μm droplets (78 pL) at a 50 μm nozzle.

For the dispersion characterization experiments, the oil phase consisted of a perfluorocarbon oil (FC40-3M) containing 2.5% (w/w) of a surfactant, made of the ammonium salt of a perfluorinated polyether (PFPE) (Krytox FSL—Dupont).²⁷ For the kinetic measurements with β-lactamase, the oil phase consisted of “R” oil with 1% (w/w) “EA” surfactant (both from Raindance Technologies). One aqueous phase for the co-flow consisted of PBS with 0.1% BSA, 20 μM Fluorocillin and 10% DMSO. The other aqueous phase consisted of PBS with 0.1% BSA and 20 nM (80 nM) β-lactamase. At a flow rate ratio of 1:1, this led to a final concentration in each droplet of 10 nM (40 nM) β-lactamase, 10 μM Fluorocillin, 0.1% BSA, 5% DMSO in PBS.

### 2. Deep Channel Delay Lines

Two simple equations are necessary to characterize the behavior of delay-lines. Equation (1) estimates the delay time t, whereby Q is the flow rate and 1, w and h represent the length, width and height of the channel. Equation (2) estimates the pressure drop P along a channel, whereby c is a constant depending on the w/h ratio (equation (3)) and 17 is the viscosity. Equation (2) is accurate to within 0.26% for any rectangular channel with w/h >1, provided that the Reynolds number is below 1000 and no bubbles, droplets or obstructions are present.²² It remains difficult to calculate P exactly for two phase microfluidic flow.²² The following example shows that the pressure over long channels can easily surpass the working limits of the pumps (˜33 bar) and of the device (delamination at ˜3 bar).²³ To obtain 10 s of delay at a total flow rate of 500 μL h⁻¹ in a channel of width w=50 μm and height h=25 μm (suitable for 30-50 μm droplets in single-file), a channel length of l=1.1 m is necessary.

According to equation (2) this leads to a back-pressure of over 100 bar (η=0.0034 Pa s for the oil and c=17.5). All the parameters affect the pressure drop linearly except for the smallest channel dimension (usually the channel height), where the pressure drop is inversely proportional to the cube of the channel height. This means that increasing the channel height will significantly reduce the pressure drop.

$$\begin{matrix}t = \frac{lwh}{Q} & ( 1 ) \\ P = c η \frac{l}{{wh}^{3}} Q & ( 2 ) \\ c = {12 [ 1 - \frac{192}{{π}^{5}} \frac{h}{w} tanh ( \frac{π w}{2 h} ) ]}^{- 1} & ( 3 )\end{matrix}$$

Therefore, the use of delay-lines with deep, wide channels allows longer droplet incubation times without any back-pressure problems. However, to create and manipulate picoliter volume droplets the channels need to have dimensions similar to the droplet size (20-100 μm). A solution to satisfy both criteria is to create a device with narrow, shallow channels where the droplets are created, split, fused, analyzed and sorted, followed by a second part to incubate droplets with deep, wide channels to avoid pressure problems and to increase delay times. An example of such a device is presented in FIG. 1 and its fabrication is described in the experimental section.

An additional approach to increase delay times and to reduce the pressure drop is to decrease the total flow rate Q. However, the aqueous flow rate cannot be reduced since it determines the throughput (droplets/second) and an oil flow rate of at least the same magnitude as the aqueous flow rate is also necessary to create well defined droplets.²⁴ A solution is to extract oil after the droplets have been formed. The device shown in FIG. 1 allows the creation of droplets at any flow rate and the subsequent oil extraction (of up to 92% of the oil) leads to a reduction of the total flow rate. With this approach, the delay time increases proportionally with the volume of oil extracted and delay times of 12 min are easily achievable even with the relatively short (l=40 cm, w=1 mm, h=75 μm) delay-line shown in FIG. 1. By further increasing the channel dimensions, even longer delay times were achieved; the longest tested (l=1 m, w=1 mm, h=150 μm) reached incubation times of up to 69 min without any back-pressure problems.

### 3. Dispersion of Incubation Times

Whereas wider and deeper channels resolve the pressure problem, the order of droplets is not necessarily maintained in these channels. A well known phenomenon in microfluidic channels is the so-called Taylor dispersion of reagents due to the parabolic flow profile within the channels (Poiseuille flow).²⁵ As a consequence, the flow rate in the center of the channel is higher than the flow rate close to the walls. Therefore, as soon as a channel is wide enough for droplets to overtake each other these different flow rates over the cross section affect the droplet flow. The central droplet stream can flow faster than the streams close to the walls, thereby leading to significant differences in the incubation times of individual droplets.

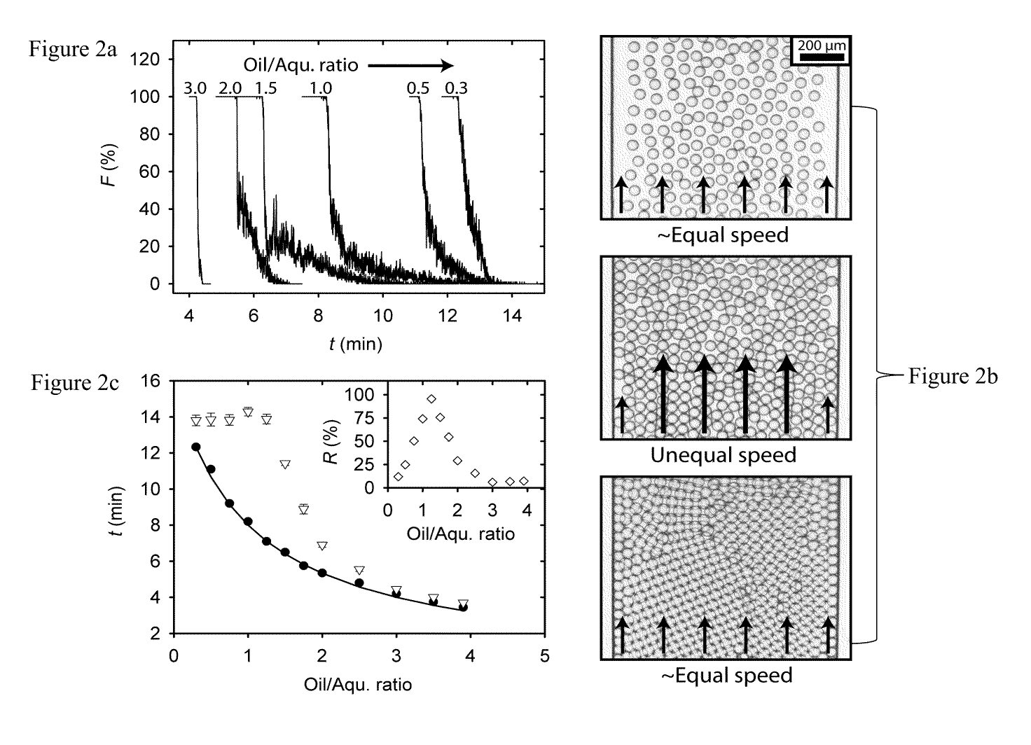

Using the device in FIG. 1 the dispersion of droplets in a delay-line was investigated. For this purpose, a stream of highly fluorescent droplets followed by a stream of low fluorescent droplets was used. The dispersion of droplets was achieved by co-flowing two streams of phosphate buffered saline (PBS) with and without 20 μM fluorescein into the nozzle. By switching the co-flow ratio from 4:1 to 1:4, two droplet populations containing different fluorescein concentrations were created directly after each other with a transition time of about 10 s. The transition time is defined as the time between the arrival of the first droplet with low fluorescence and the arrival of the last droplet with high fluorescence (followed by a continuous sequence of at least 10⁶ low fluorescence droplets). A LabView program controlled the flowrates, and recorded the fluorescence intensity of individual droplets at the end of the delay-line. The recording was started when the ratio of the co-flow was switched so that the start of the transition corresponds to the delay time and the duration of this transition is the transition time. The percentage of high fluorescent droplets F was evaluated in packages of 100 droplets. The corresponding values were plotted into a time trace (see FIG. 2a) and no dispersion could be assumed if the transition time was still within 10 s at the end of the delay-line.

However, under many conditions much longer transition times were observed (see FIG. 2a). A systematic analysis showed that the droplet density has a strong effect on the dispersion. For this analysis, droplets were generated under identical conditions (resulting in a constant droplet volume of 78 pL and a diameter of 53 μm) while changing the droplet density by extracting different volumes of oil (FIG. 2a). At low droplet densities (oil/aqueous ratio of ≧3), a sharp transition (no dispersion) was observed. With increasing droplet density the transition became longer. In this regime, typically about 50-60% of the highly fluorescent droplets population passed through almost at the same time while the rest was significantly retarded. For example at an oil/aqueous ratio of 1.25 some droplets needed 6 min to pass the delay-line while others needed up to 11 min. Finally, at very high droplet densities the transition time decreased again.

These observations can be explained by referring to FIG. 2b. At low droplet densities most of the droplets remain in the fastest streamlines in the middle of the channel and flow at almost equal speeds. At medium densities, droplets get pushed outwards to the walls where they experience lower flow rates and are overtaken by the more central droplets. At very high densities, the droplets adopt a crystal-like packing, making overtaking almost impossible, and move the droplets as one block through the channel.

FIG. 2c summarizes the dispersion ratio R (transition time/delay time ratio) of the droplets at different oil/aqueous ratios. The dispersion is very important for the mid-range of oil/aqueous ratios with values of R as high as >90%. In this regime, any quantitative analysis of reaction kinetics becomes impossible since the incubation times vary almost over a 2-fold range. In the low density regime (right part of the graph), the dispersion is low (R≦10%), but the delay time may not be sufficiently long. Therefore, the high density regime would be desirable since both the delay time is long and the dispersion low (R≦15%). However, it remains difficult to run the system in this regime. The slope of the curve is very steep and small changes in the volume fraction of the extracted oil can increase the dispersion by minutes. Furthermore, the system is not very flexible, since only the lowest oil/aqueous ratio can be used, limiting the spectrum of accessible delay times for a given design.

### 4. Reducing Dispersion of Incubation Times

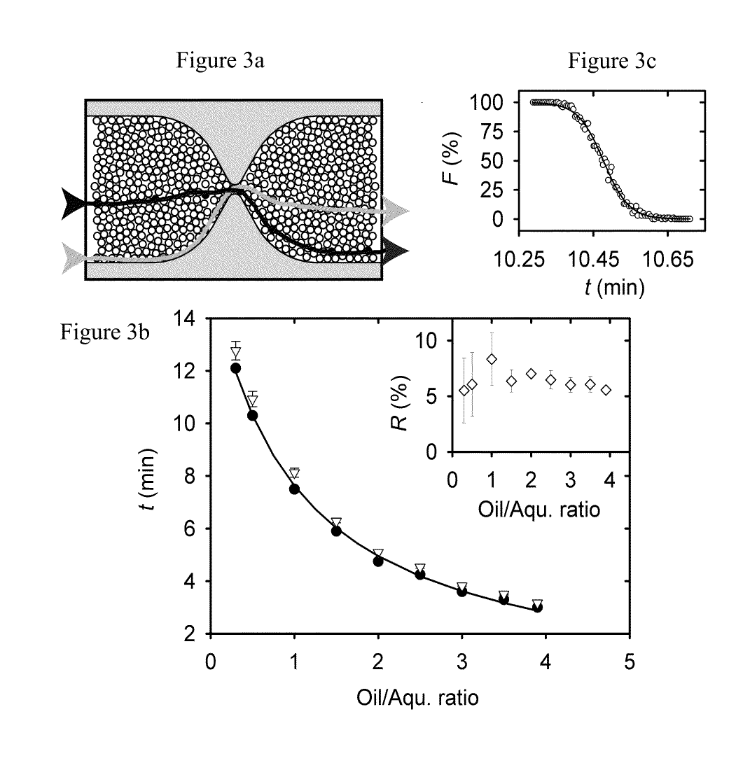

To address the problem of dispersion, two different approaches were tested. The first approach consisted of preventing the droplets from overtaking each other by dividing the channel into multiple narrow channels (described below and FIG. 5). The second strategy consisted of repeatedly shuffling droplets by introducing constrictions every 3 cm along the delay-line (FIG. 3a). These constrictions reduce the channel width to the dimension of a droplet and result in a repeated mixing of the droplets over the channel cross section, preventing the same droplets from remaining in the same (faster or slower) flow lines. This random re-distribution was verified by analyzing high speed movies.

Indeed, after testing several different constriction designs, a significantly reduced dispersion (R≦10%) was found (FIG. 3b) compared to the delay-line without constrictions (FIG. 2c). Furthermore, the shape of the transition changed. For a delay-line without constrictions, the slow droplets lead to a long ‘tail’ as can be seen in FIG. 2a (e.g. oil/aqueous ratio of 1.5 or 1.0) and the transition is non-symmetrical. In contrast, for the delay-line with constrictions the shape of the transition becomes symmetrical (FIG. 3c). The incubation times of individual droplets in the delay-line are equally distributed around a mean value and the transition can be perfectly fitted with a logistic function, which corresponds to a Gaussian distribution of the incubation time. This Gaussian distribution is obtained at all droplet densities and the width of the distribution (which is a measure for the dispersion) scales proportionally with the incubation time of the droplets in the delay-line. With this improvement, the whole system becomes more stable and reproducible and opens up an important range of new applications.

### 5. Delay Lines Comprising Multiple Parallel Channels

In addition to the delay-line with constrictions, an alternative layout was tested. The strategy used was not to reduce dispersion but to prevent dispersion from occurring by removing the possibility for droplets to overtake each other. The design consists of multiple parallel narrow channels (see FIG. 5), that are not wider than twice the droplet diameter. As a result, there can not be any fast central stream of droplets within these channels. Provided that the flow rates in the different channels are equal, the expectation is that there would not be any dispersion.

Initial designs allowed an exchange of flow between the narrow channels only at the beginning and at the end of the delay-line. As a consequence, any irregularity (dirt, channel depth fluctuations, etc.) present in one of the channels completely destabilized the system. In order to reduce this problem, bridges were added between the channels every 3 cm. This strategy improved the system but a completely homogenous flow across all the channels could not be achieved. For this reason the relative dispersion ratio, as seen in FIG. 5, still reaches values above 50%. Although it is a clear reduction of the dispersion compared to the conventional delay-line (FIG. 2c—max R>90%), this layout is outperformed by the delay-line with constrictions (FIG. 3b— R<10%). Additionally, this multiple channel approach requires more space on the chip to get the same volume as a single wide channel of the same length. Furthermore, the fluidic resistance is higher for multiple channels (equation (2)), which limits the practical length of the delay-line (hence the maximum incubation time). In summary, the multiple channels approach has the potential to prevent dispersion.

### 6. Measurement of Enzyme Kinetics

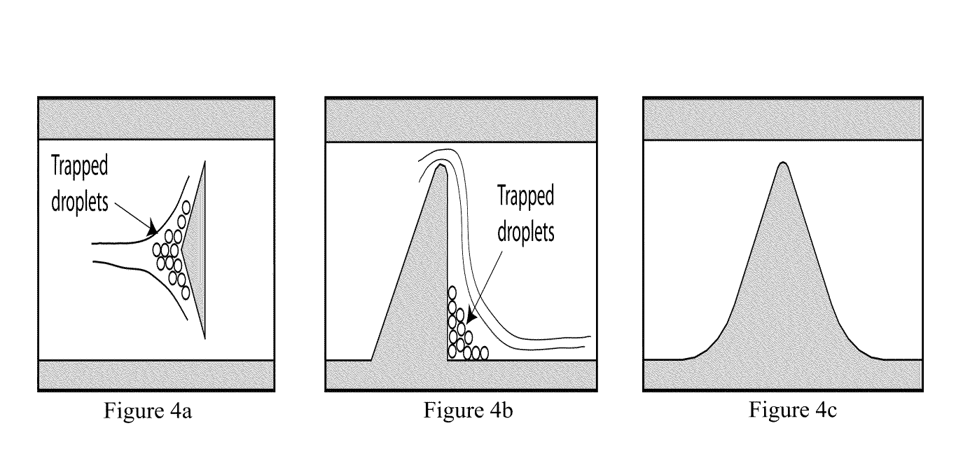

As a first demonstration of the delay-line reliability, the kinetic of an enzymatic reaction was measured. The turnover of the fluorogenic substrate Fluorocillin by the enzyme β-lactamase was detected over a range of several minutes in the delay-line. For this purpose, an additional feature was introduced into the layout of the delay-line. Whereas the geometry of the delay-line in FIG. 1 only allowed a single measurement at the end of the delay-line, now several additional measurement points were introduced between the inlet and the outlet (FIG. 4a). These measurement points were designed within the narrow and shallow channels to obtain sufficient spacing between the droplets and also to confine them laterally for the fluorescence detection. Droplets therefore moved back and forth between the deep channels for incubation and the narrow channels for measurements.

When performing measurements at several points along the delay-line the droplet density is an important factor. If the droplets are packed too densely the fluorescence signal of individual droplets cannot be resolved anymore. Therefore, these experiments need to be carried out at an oil/aqueous ratio that provides a good compromise between delay times and droplet spacing. This ratio corresponds exactly to the intermediate regime where the dispersion in a delay-line without constrictions is the highest. In contrast, for the delay-line with constrictions this medium packed regime is practically accessible without dispersion. Furthermore, since the dispersion is no longer influenced by the droplet density, a whole range of incubation times can be reached by varying the amount of oil extracted.

FIG. 6b shows the fluorescence signal of the β-lactamase reaction measured at different time points. At each point the distribution is Gaussian as expected and the standard deviation is directly proportional to the mean fluorescence. Furthermore, the measured kinetics follows exactly the same trend as in the assay performed in a cuvette (Inset, FIG. 6b), showing that the system is fully biocompatible and accurate. These results clearly show that the improved delay-line layout is a very well-suited system to analyze enzymatic reactions in a fast, convenient and reliable way.

In summary, the present invention address the problems associated with designing delay-lines to allow on-chip incubation times up to 3 hours for droplet-based microfluidics systems. Moreover, the present invention provides solutions to two fundamental problems, namely the problems of pressure and unequal incubation times of droplets in the delay-lines (dispersion). The back pressure of the system can be reduced by using a two depth device with wide, deep channels for droplet incubation and narrow, shallow channels for the generation and manipulation of droplets. The extraction of oil directly after droplet generation further reduces the back pressure and facilitates even longer incubation times, which may easily reach the hour range. In addition, the extraction of oil broadens the range of incubation times, accessible for a given delay-line design. A general solution to the dispersion problem is the use of constrictions that redistribute the droplets repeatedly along the delay-line. This repeated shuffling of droplets leads to a significant reduction in the dispersion of incubation times and distributes these times equally (Gaussian) around a mean value. These improvements allow the creation of integrated droplet-based microfluidic systems for a wide range of (bio)chemical reactions, containing multiple modules, including delay lines which allow reaction times of 1 min to >1 hour. Finally, validation of the delay-line system was achieved by measuring the reaction kinetics of the enzyme β-lactamase on-chip: the reactions kinetics were identical to a conventional cuvette-based assay.

### 7. Optical System for Droplet Observation and Fluorescence Detection

Referring now to FIG. 7, depicting a schematic representation of the optical setup. The 488 nm laser is reflected by a dichroic beamsplitter (DBS) into the microscope. Inside the microscope, the laser is reflected at a beamsplitter (BS) and focused into the microfluidic channel by a 40× objective. The emitted fluorescent light and the light of the lamp pass back through the microscope and reach either the highspeed camera or pass through the filters (Notch filter NF and emission filter EF). The emission filter is a bandpass filter transmitting 504±20 nm to the PMT which records the light intensity.

As illustrated in FIG. 7, a 488 nm laser source was used to excite the fluorophores contained in the droplets. The laser was focused in the channels through a 40× microscope objective (Leica). Fluorescence emission was filtered with an appropriate set of filters (Semrock Inc.) in the 484-524 nm range (fluorescein detection) and then collected with a photomultiplier tube (Hammamatsu). Fluorescence detection was driven by a data-acquisition system (Labview, National Instruments) that also allowed signal processing and statistical analysis. Additionally, a high speed camera (Phantom V4.2 at 2-10×10³ frames per second) recorded sequences of images of the droplet movement in the channels.

### 8. Cloning Expression and Purification of 13-Lactamase

In order to produce purified β-lactamase for the enzymatic assay, His-tagged β-lactamase was expressed in the periplasm of E. coli and subsequently purified from periplasmic extracts using a Ni²⁺-NTA column.

The plasmid used is a derivative of the plasmid pAK400 (Krebber et al., J. Immunol. Methods, 1997, 201, 35-55), which already codes for a C-terminal His-tag. The plasmid contains the strong RBS T7G10 and a pelB signal peptide for periplasmic expression, which is flanked by an upstream XbaI and a downstream Ncol site. In contrast to pAK400, which possesses a lac promoter, the derivative used here contains the arabinose inducible promoter of the pBAD series of plasmids (Invitrogen, Cergy Pontoise, France). To obtain this new plasmid the lac promoter region had been replaced with a DNA fragment coding for the araC repressor and the araBAD promoter. Furthermore, an EcoRI site had been introduced before the C-terminal His-tag. For the cloning of β-lactamase, a pUC based plasmid having ampicillin resistance (pIVEX series; Roche Applied Science, Meylan, France) was used as the PCR template. β-lactamase was amplified together with its signal peptide using the primers bla_forty_Xba 5′-GCTCTAGAGAAGGAGATATACA-TATGAGTATTCAACATTTCCGTG-3′ (SEQ ID NO:1) and bla_rev_EcoRI 5′-GGAATTCCCAATGCTTAATCAGTGAGG-3′ (SEQ ID NO:2). The PCR fragment was purified, cut with XbaI and EcoRI and cloned into the pAK400 derivative thereby replacing the pelB signal sequence. The new plasmid was verified by sequencing.

The plasmid was transformed into the E. coli K12 strain TB1 (New England Biolabs, Frankfurt, Germany). The cultures for the purification were grown at 25° C. in 400 ml of SB medium (20 g l⁻¹ tryptone, 10 g l⁻¹ yeast extract, 5 g l⁻¹ NaCl, 50 mM K₂HPO₄) containing 30 μg ml⁻¹ chloramphenicol. This culture was inoculated from a 20 ml preculture to OD₆₀₀=0.1. Expression was induced with 0.02% arabinose at an OD₆₀₀ between 1.0 and 1.5. The cells were harvested 3 h after induction by centrifugation at 5000 g and 4° C. for 10 min.

Periplasmic extracts were prepared according to a protocol included in the manual for the Ni²⁺-NTA columns (Qiagen, Courtaboeuf, France). The extracts were dialyzed against loading buffer (50 mM sodium phosphate pH 8.0, 300 mM NaCl, 10 mM imidazole) and loaded onto the Ni²⁺-NTA column equilibrated with loading buffer. The column was washed with 30 column volumes of loading buffer and 5 column volumes of a washing buffer (50 mm sodium phosphate pH 8.0, 300 mM NaCl, 30 mM imidazole). Elution was achieved by adding 5 column volumes of elution buffer (50 mM sodium phosphate pH 8.0, 300 mM NaCl, 200 mM imidazole). The eluted material was dialyzed against phosphate buffered saline (PBS; 10 mM Na phosphate, pH 7.4, 137 mM NaCl, 2.7 mM KCl) and concentrated using Ultrafree-4 (Millipore, Molsheim, France). The purity was confirmed by SDS-PAGE. The concentration of β-lactamase was determined by measuring the absorbance at 280 nm. The extinction coefficient was calculated using the program Vector NTI (Invitrogen). Finally, the concentration was adjusted to 1 mg ml⁻¹ (corresponding to 32.6 μM) and the protein was stored in aliquots at −80° C.

### REFERENCES

1 D. S. Tawfik and A. D. Griffiths, Nat. Biotechnol., 1998, 16, 652-656.
2 O. J. Miller, K. Bernath, J. J. Agresti, G. Amitai, B. T. Kelly, E. Mastrobattista, V. Taly, S. Magdassi, D. S. Tawfik and A. D. Griffiths, Nat. Methods, 2006, 3, 561-570.
3 B. T. Kelly, J.-C. Baret, V. Taly and A. D. Griffiths, Chem. Commun., 2007, 1773-1788.
4 V. Taly, B. T. Kelly and A. D. Griffiths, Chembiochem, 2007, 8, 263-272.
5 E. R. Mardis, Annu. Rev. Genomics Hum. Genet., 2008, 9, 387-402.
6 S. L. Anna, N. Bontoux and H. A. Stone, Appl. Phys. Lett., 2003, 82, 364-366.
7 H. Song, J. D. Tice and R. F. Ismagilov, Angew. Chem. Int. Ed., 2003, 42, 768-772.
8 D. R. Link, S. L. Anna, D. A. Weitz and H. A. Stone, Phys. Rev. Lett., 2004, 92, 054503.
9 K. Ahn, J. Agresti, H. Chong, M. Marquez and D. A. Weitz, Appl. Phys. Lett., 2006, 88, 264105.
10 D. R. Link, E. Grasland-Mongrain, A. Duni, F. Sarrazin, Z. Cheng, G. Cristobal, M. Marquez and D. A. Weitz, Angew. Chem. Int. Ed., 2006, 45, 2556-2560.
11 B. Zheng, L. Roach and R. Ismagilov, J. Am. Chem. Soc., 2003, 125, 11170-11171.
12 H. Song and R. F. Ismagilov, J. Am. Chem. Soc., 2003, 125, 14613-14619.
13 J. Clausell-Tormos, D. Lieber, J.-C. Baret, A. El-Harrak, O. J. Miller, L. Frenz, J. Blouwolff, K. J. Humphry, S. Köster, H. Duan, C. Holtze, D. A. Weitz, A. D. Griffiths and C. A. Merten, Chem. Biol., 2008, 15, 427-437.
14 S. Koester, F. E. Angile, H. Duan, J. J. Agresti, A. Wintner, C. Schmitz, A. C. Rowat, C. A. Merten, D. Pisignano, A. D. Griffiths and D. A. Weitz, Lab Chip, 2008, 8, 1110-1115.
15 S. Xu, Z. Nie, M. Seo, P. Lewis, E. Kumacheva, H. A. Stone, P. Garstecki, D. B. Weibel, I. Gitlin and G. M. Whitesides, Angew. Chem. Int. Ed., 2005, 44, 724-728.
16 T. Nisisako and T. Torii, Lab Chip, 2008, 8, 287-293.
17 T. Hatakeyama, D. L. Chen and R. F. Ismagilov, J. Am. Chem. Soc., 2006, 128, 2518-2519.
18 Z. T. Cygan, J. T. Cabral, K. L. Beers and E. J. Amis, Langmuir, 2005, 21, 3629-3634.
19 I. Shestopalov, J. D. Tice and R. F. Ismagilov, Lab Chip, 2004, 4, 316-321.
20 L. Frenz, A. E. Harrak, M. Pauly, S. Bégin-Colin, A. D. Griffiths and J.-C. Baret, Angew. Chem. Int. Ed., 2008, 47, 6817-6820.
21 Y. N. Xia and G. M. Whitesides, Annu. Rev. Mater. Sci., 1998, 28, 153-184.
22 M. J. Fuerstman, A. Lai, M. E. Thurlow, S. S. Shevkoplyas, H. A. Stone and G. M. Whitesides, Lab Chip, 2007, 7, 1479-1489.
23 M. Eddings, M. Johnson and B. Gale, J. Micromech. Microeng., 2008, 18, 067001.
24 P. Garstecki, M. J. Fuerstman, H. A. Stone and G. M. Whitesides, Lab Chip, 2006, 6, 437-446.
25 G. I. Taylor, Proc. R. Soc. A, 1953, 219, 186-203.
26 J. R. Anderson, D. T. Chiu, R. J. Jackman, O. Cherniayskaya, J. C. McDonald, H. Wu, S. H. Whitesides and G. M. Whitesides, Anal. Chem., 2000, 72, 3158-3164.
27 K. P. Johnston, K. Harrison, M. Clarke, S. Howdle, M. Heitz, F. Bright, C. Carlier and T. W. Randolph, Science, 1996, 271, 624.
28. Keunho Ahn, Charles Kerbage, Tom P Hunt, R. M Westervelt, Darren R Link, D. A Weitz. Dielectrophoretic manipulation of drops for high-speed microfluidic sorting devices. Appl Phys Lett, 2006, 88 (2) pp. 024104.
29. Jean-Christophe Baret, Oliver J Miller, Valerie Taly, Michael Ryckelynck, Abdeslam El-Harrak, Lucas Frenz, Christian Rick, Michael L Samuels, J. Brian Hutchison, Jeremy J Agresti, Darren R Link, David A Weitz, Andrew D Griffiths. Fluorescence-activated droplet sorting (FADS): efficient microfluidic cell sorting based on enzymatic activity. Lab on a chip. 2009, 9 (13) pp. 1850-1858
30. A. D. Stroock, S. K. W. Dertinger, A. Ajdari, I. Mezic, H. A. Stone, and G. M. Whitesides, “Chaotic mixer for microchannels,” Science, vol. 295, pp. 647-651, January 2002.
31. R. H. Liu, M. A. Stremler, K. V. Sharp, M. G. Olsen, J. G. Santiago, R. J. Adrian, H. Aref, and D. J. Beebe, “Passive mixing in a three-dimensional serpentine microchannel,” J. Microelectromech. Syst, 9, pp. 190-197, 2000.

1. A microfluidic device comprising a delay line allowing the incubation of droplets flowing in a carrier oil for defined times, in which the height or the width of the delay line in all, or certain, regions exceeds the width of the droplets.


SEQUENCE LISTING (2 sequences)

SEQ ID NO: 1 - DNA, 45 bp, Artificial Sequence
  bla_forw_Xba primer
gctctagagaaggagatatacatatgagtattcaacatttccgtg

SEQ ID NO: 2 - DNA, 27 bp, Artificial Sequence
  bla_rev_EcoRI primer
ggaattcccaatgcttaatcagtgagg